(19) United States
(12) Patent Application Publication
(10) Pub. No.: US 2009/0148127 A1
(43) Pub. Date: Jun. 11, 2009

(54) SYSTEM AND METHOD FOR GENERATING A MEDIA PRODUCT

(75) Inventor: Nicholas Porrini, West Chester, PA (US)

Correspondence Address: PEPPER HAMILTON LLP, ONE MELLON CENTER, 50TH FLOOR, 500 GRANT STREET, PITTSBURGH, PA, 15219, US

(73) Assignee: DIGITAL ALL-STAR, LLC, West Chester, PA (US)

(21) Appl. No.: 12/329,882

(22) Filed: Dec. 8, 2008

Related U.S. Application Data
(60) Provisional application No. 61/012,218, filed on Dec. 7, 2007.

(51) Int. Cl. H04N 5/93

(52) U.S. Cl. 386/52; 386/E05.001

(57) ABSTRACT

A system for creating a customized video may include a memory, a portable structure, one or more props, a camera and a computing device. The memory may be configured to store a digital representation of a scene from action footage of a sporting event. The portable structure may be configured to provide a location to reenact the scene. The structure may include a surface of the structure comprising a monochromatic material. The one or more props may be related to the scene. The camera may be configured to record a reenacted scene inside the structure. The computing device may be configured to merge the reenacted scene with the scene from the action footage to create a customized video in which the monochromatic material is replaced by the action footage.

### PRIORITY

This patent application claims priority to U.S. Provisional Patent No. 61/012,218, entitled “System and Method for Generating a Media Product,” filed on Dec. 7, 2007, which is hereby incorporated by reference in its entirety.

### BACKGROUND

For many years, people of all ages have expressed a desire to be a professional athlete such as a baseball player, a football player, a basketball player, a soccer player, a golfer, a race car driver, etc. Unfortunately, for a variety of reasons, the overwhelming majority of these people have been unable to actually realize such desires.

### SUMMARY

In an embodiment, a system for creating a customized video may include a memory configured to store a digital representation of a scene from action footage of a sporting event. The system may include a portable structure configured to provide a location to reenact the scene, wherein the structure comprises a surface of the structure comprising a monochromatic material. The system may include one or more props related to the scene and a camera configured to record a reenacted scene inside the structure. The system may include a computing device configured to merge the reenacted scene with the scene from the action footage to create a customized video in which the monochromatic material is replaced by the action footage.

In an embodiment, the scene from the action footage may include an award ceremony, an interview and/or a sporting event. The system may include one or more back lighting structures. In an embodiment, the system may include one or more markers for positioning a participant. In an embodiment, the one or more props may include a baseball glove, a baseball uniform, a baseball hat, and/or a baseball. In an embodiment, the portable structure may include a tent. In an embodiment, the portable structure may include a truss. In an embodiment, the monochromatic material may be further configured to cover a floor. The floor may include an elevated area representing a pitcher's mound.

In an embodiment, a method of creating a customized video may include preparing a portable structure. A surface of the structure may include a monochromatic material. One or more props may be positioned inside the structure. A scene may be received from action footage of a sporting event. A reenacted sports scene may be recorded inside the portable structure. The recording of the reenacted sports scene may be merged with at least a portion of the scene from the action footage to create a customized video in which the monochromatic material is replaced by the action footage.

In an embodiment, the recording the reenacted scene may include recording an interview, recording a fly ball being caught and/or recording a player hitting a homerun. In an embodiment, recording the reenacted scene may include playing sound effects to assist a participant. In an embodiment, preparing the portable system may further include setting up one or more props, setting up one or more markers and/or setting up the lighting. In an embodiment, props associated with the action footage may be provided. In an embodiment, one or more markers may be adjusted based on a height of a participant. In an embodiment, the monochromatic material may be adjusted based on a height of a participant.

In an alternate embodiment, a method of creating a customized sports video may include preparing a portable structure. The portable structure may include setting up monochromatic material on two sides and a portion of a floor of the structure, setting up one or more props inside the portable structure, and setting up one or more markers inside the portable structure. A scene from action footage of a sporting event may be received. A reenacted sports scene may be recorded inside the portable structure. The recording of the reenacted sports scene may be merged with at least a portion of the scene from the action footage to create a customized video in which the monochromatic material is replaced by the action footage.

In an embodiment, the action footage and the reenacted sports scene may be edited. In an embodiment, the one or more markers may be adjusted based on a height of a participant. In an embodiment, setting up monochromatic material may include setting up monochromatic material to cover an elevated area on the floor representing a pitcher's mound. In an embodiment, recording the reenacted scene may include playing sound effects to assist a participant. In an embodiment, recording the reenacted scene may include recording an interview, recording a touchdown and/or recording an awards ceremony.

### BRIEF DESCRIPTION OF THE DRAWINGS

Aspects, features, benefits and advantages of the embodiments described herein will be apparent with regard to the following description, appended claims, and accompanying drawings where:

FIG. 1 illustrates an exemplary system for generating a media product according to an embodiment.

FIG. 2 illustrates an exemplary method for generating a media product according to an embodiment.

### DETAILED DESCRIPTION

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

As used herein and in the appended claims, the singular forms “a,” “an,” and “the” include the plural reference unless the context clearly dictates otherwise. Thus, for example, reference to a “lighting fixture” is a reference to one or more lighting fixtures and equivalents thereof known to those skilled in the art, and so forth. Unless defined otherwise, all technical and scientific terms used herein have the same meanings as commonly understood by one of ordinary skill in the art. As used herein, the term “comprising” means “including, but not limited to.”

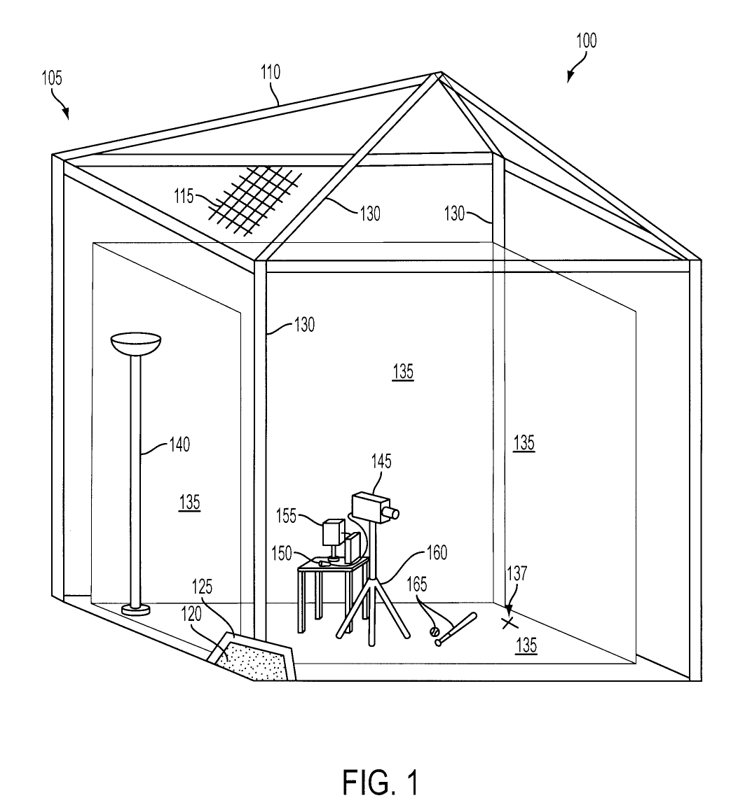

FIG. 1 illustrates various embodiments of a system for generating a media product. The system 100 may include a structure 105. The structure 105 may be embodied as any suitable type of studio. In an embodiment, the structure 105 may be, but is not limited to a tent, a trailer, a truss, a portable structure or a permanent structure. For ease of explanation purposes, the system 100 will be described with reference to the structure 105 shown in FIG. 1.

The structure 105 can be assembled and disassembled at any number of different locations. For example, the structure 105 may be set up at a baseball stadium, a football stadium or a race track. The structure 105 may be assembled or disassembled without the use of tools. The structure 105 may be of any suitable size and shape, and may include a frame assembly 110 and a covering 115 secured to the frame assembly 110. For purposes of clarity, only a portion of the covering 115 is shown in FIG. 1. The system 100 may include a plurality of foot plates 120 positioned between the frame assembly 110 and the floor/ground. The system 100 may include a plurality of base plates 125 positioned between the frame assembly 100 and the foot plates 120.

The frame assembly 110 may include a plurality of frame members 130 which are interconnected to form a basic shape of the structure 105. For example, as shown in FIG. 1, the frame members 130 may be interconnected to form a four sided structure having a square roof. The frame members 130 may be of any suitable size and shape. In an embodiment, the frame members 130 may be embodied as poles or tubes. In an embodiment, the height and/or length of at least some of the frame members 130 may be adjustable in order to vary the size and/or shape of the structure 105.

The covering 115 may be fabricated from any suitable material and may be secured to the frame assembly 110 in any suitable manner. The covering 115 may comprise any number of sections. In an embodiment, the covering 115 may be fabricated from a high-quality fade-resistant, close-mesh polyester material. The material may comprise, without limitation, a material which is resistant to microorganisms, certified fire-resistant, stain resistant, washable, windproof or wind resistant, waterproof or water resistant and/or tear resistant. In an embodiment, the covering 115 may be secured to the frame assembly 110 with hook and loop fasteners. In an embodiment, the sections of the covering 115 may cooperate with the frame assembly 110 to form the roof and at least three of the walls of the structure 105. In an embodiment, one of the walls of the portable structure 105 may not include any covering 115.

The system 100 may include monochromatic material 135 positioned inside the structure 105. In an embodiment, monochromatic material 135 may be the surface of the structure. In an embodiment, monochromatic material 135 may cover at least a portion of a wall of the structure 105. In an embodiment, the monochromatic material 135 may be positioned over at least three walls of the structure 105 and on the ground/floor covered by the structure 105. In an embodiment, the monochromatic material 135 may be positioned on one or more sides of the structure 105. In an embodiment, the monochromatic material 135 may be positioned on at least two sides of the structure 105 and cover at least a portion of the floor of the structure 105.

The monochromatic material 135 may be continuous over three walls of the structure 105. The monochromatic material 135 may be a green, fuchsia, magenta or blue screen. The monochromatic material 135 may be fabricated from any suitable material. For example, the monochromatic material 135 may be fabricated from a foam type material. The monochromatic material 135 may be connected to the frame assembly 110 and/or the covering 115 in any suitable manner. For example, the monochromatic material 135 may be connected to the frame assembly 110 and/or the covering 115 with hook and loop fasteners.

In an embodiment, one or more markers 137 may be placed on the monochromatic material 135. Markers 137 are visual signals for a participant. The markers 137 may be used to indicate where the participant should stand, look or move during a scene. Markers 137 may include, but are not limited to, signs, tape, and/or a light.

The system 100 may include one or more lighting fixtures 140. The number and type of lighting fixtures 140 may vary based on the size of the structure 105. A given lighting fixture 140 may include, but is not limited to, a halogen bulb, an incandescent bulb and/or a fluorescent bulb. In an embodiment, a lighting fixture with a fluorescent bulb may be used due to the low amount of heat emitted. In an embodiment, standard lighting fixtures may be used in a well-ventilated or air conditioned area. In an embodiment, one or more lighting fixtures 140 may be hung and/or placed on stands. In an embodiment, one or more lighting fixtures 140 may be positioned directly across from the monochromatic material 135 to avoid a shadow. In an embodiment, one or more lighting fixtures 140 may be positioned or directly above or below the monochromatic material 135 or the participant.

The system 100 may include one or more cameras 145. A camera 145 may include, but is not limited to, a still camera, a video camera, or other medium used to capture an image. In an embodiment, a camera may be used to record a participant or actor. In an embodiment, the camera 145 may be a professional quality video camera with audio inputs, and may be used to transmit an image in real time. As shown in FIG. 1, the camera 145 may be mounted on a tripod 160. The camera 145 may be in communication with a microphone 150 and/or a display 155. The display 155 may be, but is not limited to, a high definition flat screen television.

The system 100 may include one or more props 165. As used herein, the term “prop” refers to an object which is utilized during the generation of the media product. In an embodiment, the props 165 may include objects related to a particular sport such as, but not limited to, baseball, football, basketball, golf and/or car racing. The specific props 165 utilized during the generation of a particular customized video may vary depending upon the type of video being generated. For example, for a baseball-related customized video, the props 165 may include, for example, a baseball, a baseball bat and/or a baseball glove. In an embodiment, some props 165, such as, but not limited to, a pitcher's mound, may be positioned under the monochromatic material 135 which may cover the ground/floor and which may be covered by the portable structure 105.

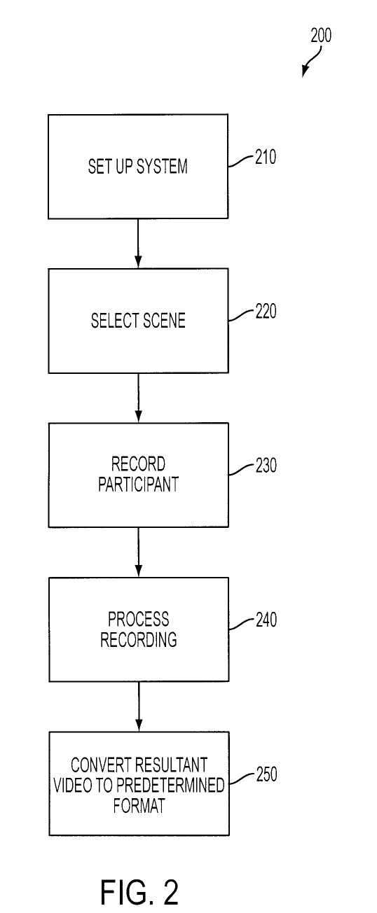

FIG. 2 illustrates various embodiments of a method 200 for generating a media product. The system may be prepared 210. Preparing may include setting up, laying out, organizing or arranging various elements of the system. As discussed above, the system may be set up at or near a location such as, but not limited to, a baseball stadium (e.g., major league, minor league, little league, etc.), a batting cage, a football stadium (e.g., professional, collegiate, high school, youth, etc.), a soccer field, a tennis court, a basketball court and/or a race car track. Setting up the system may include, for example, setting up the portable structure, the monochromatic material, one or more lighting fixtures, one or more cameras, one or more markers and/or any applicable props.

One or more scenes to be subsequently reenacted may be selected 220 from action footage. Action footage may include dynamic images or a dynamic series of shots which are recorded. In an embodiment, action footage may be recorded by a video camera. In an embodiment, the scenes from the action footage may be scenes from one or more sporting events. In an embodiment, the scenes from the action footage may be scenes from sports history. Various criteria may be used to select the scenes. For example, a given scene may be selected if the scene is steady and/or contains little movement.

A participant may be recorded 230 while reenacting the scene. One or more cameras may be utilized to record the participant reenacting the scene. A reenacted scene may include a studio with embedded images or video of a participant acting in one or more sporting events. The reenacted scene may be recorded in color for a modern effect or in black and white for a nostalgic effect. The reenacted scene may be recorded at any suitable speed. For example, the reenacted scene may be recorded at thirty frames per second.

In an embodiment, the lighting fixtures and camera placement, angle and/or height may vary depending on the scene and the participant's height. For example, if the participant is a small child, the cameras and/or lighting fixtures may be lower than if the participant is an adult. The lighting may vary depending on the participant to ensure that no shadows are created while recording the scene.

The participant may utilize 235 various props while reenacting the scene. For a given sports scene, the props may be related to that sport. For example, for a baseball scene, the props may include, but are not limited to, a baseball, a baseball bat, a baseball glove and/or a baseball uniform. For a football scene, the props may include, but are not limited to, a football, a football helmet and/or a football uniform. For a soccer scene, the props may include, but are not limited to, a soccer ball, a soccer uniform, and/or a soccer goal with netting. For a golf scene, the props may include, but are not limited to, golf clubs and/or golf balls. For a race car scene, the props may include, but are not limited to, a steering wheel, a race car (or a portion of a race car), a helmet, a fire suit and/or a trophy. For a tennis scene, the props may include, but are not limited to, a tennis ball, a tennis racket, a tennis net and/or a trophy. The props may be made to appear like the actual item in size, shape and color. However, the props may be replicas which are made from a different material and/or are hollow inside.

The participant may be recorded against the monochromatic material. The height or width of the monochromatic material may vary based on the size of the participant.

There may be different scenes associated with each sport. For example, in baseball scenes the participant may, without limitation, hit a baseball, run the bases, pitch the baseball, catch the ball, throw the ball and/or be interviewed after a game. The baseball scenes may also include, for example, a close shot of the participant as the batter, a close shot of the participant as the batter from behind, front and/or side as the participant prepares for the pitch, a long and/or a short shot of the batter waiting on or near a base getting ready to run, a close and/or long shot from the behind, front and/or the side of the participant getting ready to pitch, a close shot of the participant as the pitcher making a face and/or giving a look to the batter, a long shot of the pitcher throwing the ball and/or a close shot of the participant giving an interview.

For example, when recording the scene with the participant as a catcher, the participant may use a catcher's glove. There may be a left handed and a right handed catcher's glove. The glove may be a glove prop that is designed to look like a real catcher's glove in size and appearance, but may be made of a lighter weight material. A baseball prop may be the size and color of a regulation major league baseball, but the ball may be lightweight material and hollow. A bat prop may be made of either plastic or a lightweight material that is dark in color and non-metallic.

Similarly, when recording the scene of the participant as a pitcher, a pitcher's mound may be used. The mound may be positioned under the monochromatic material which covers the floor/ground. As the mound is positioned under the monochromatic material, the participant may be recorded as if standing on a baseball mound in the scene from the action footage. The height of the mound may be adjustable. In an embodiment, the height of the mound may be increased or decreased based on the height of the participant being recorded. In an embodiment, the participant on the mound may be at a predetermined height so that the video created with the participant may be merged with the scene from the action footage of a baseball player pitching.

In order to achieve proper placement to record the participant pitching the baseball, a marker may be placed on the pitcher's mound. The marker may be used to indicate where the participant should stand. A marker may be placed on the wall to indicate where the participant should throw the ball. Markers may be placed in various locations based on the angle of the pitch and/or the height of the participant. Markers may also be used to indicate where the participant should look during a play. For a batting scene, a ball may be hung by a monofilament line. The height of the ball may vary based on the height of the participant.

In football scenes, the participant may, without limitation, pass a football, kick a football, catch a pass, celebrate a touchdown and/or tackle another player. In basketball scenes, a participant may, without limitation, dribble a basketball, pass a basketball, shoot a basketball, steal a basketball from another player and/or block a shot. In soccer scenes, a participant may, without limitation, dribble a soccer ball, kick a soccer ball, score a goal, strip a soccer ball from an opposing player and/or catch a soccer ball as a goalie. In golf scenes, a participant may, without limitation, swing a golf club, putt and/or wave to the crowd. In race car scenes, a participant may, without limitation, sit in a race car, drive/steer the race car and/or celebrate in victory lane. In tennis scenes, a participant may, without limitation, serve, volley and/or swing forehand and/or backhand.

In an embodiment, sound effects may be utilized in the background while recording the scene to assist the participant in reenacting the scene. Sound effects may include, for example, booing, gasps, and/or cheers.

In an embodiment, the participant may be recorded answering 237 questions to an interview. In an embodiment, the interview questions may be rehearsed with the participant prior to the recording of the scene. The interview questions may pertain to the event reenacted by the participant.

In an embodiment, the scene may include the participant in a variety of sports segments such as, but not limited to, player of the game, player of the year, plays of the week, plays of the game and/or a sponsorship advertisement or commercial.

In an embodiment, a family member or friend of the participant may have a role in the scene. For example, in a baseball scene, a family member of the participant may catch a home run ball hit by the participant. The scene with the family member may also be recorded using the green screen material of the system as a backdrop. Markers may be placed showing the family member where to stand, look and/or catch a ball.

The recording may be processed 240 in order to merge the reenacted scene with the scene from the action footage to create a video. For example, the scene from the action footage may be major league baseball (MLB) footage. The scene from the action footage may be edited. In an embodiment, programs such as, but not limited to, Avid Express Pro HD™ from Avid Technology, Inc. and/or Final Cut Pros from Apple, Inc. may be used to edit the action footage.

In various embodiments, the reenacted scene may be digitized into a nonlinear editing system along with the scene from the action footage. Several effects may be added to the footage of the reenacted scene, such as, but not limited to, chroma key, color correction, blur, shadow, resize and repositioning effects. The best shots may be selected. After the best shots are selected, the footage of the reenacted scene may be combined with the edited scene from the action footage.

In an embodiment, a frame of a scene from the action footage may be edited to remove a player and replace a missing section with the participant. In an embodiment, in order to remove a player from the scene in the action footage scene, a digital still may be taken. The file of the digital still may be imported into a graphics editor. Elements of the scene of the action footage may be extracted to create a generic slate.

In an embodiment, alternate scenes may be added to the media product. For example, a scene may be added that includes a newscast featuring highlights of a sporting event and a voiceover discussing statistics regarding the participant's performance in the sporting event. A scene may be added showing the participant talking to other players before and/or after a sporting event, showing the participant in an All Star lineup prior to the start of the game, showing the participant giving autographs at the end of the sporting event and/or showing a jersey with the participant's name at the Hall of Frame.

In an embodiment, the scenes from the action footage and reenacted scenes may be merged using time codes. A time code burn may used for the scenes from the action footage to determine the exact timing of the scenes to be edited. In an embodiment, the scene from the action footage may be mapped. One or more scenes may be selected to be used from the action footage. Time codes may be technically evaluated.

In an embodiment, the scene of the action footage may be digitized. For a first rough draft, only the video portion of a scene may be edited. Audio portions may be reenacted in a postproduction process. Audio portions may include, but are not limited to, voice over commentary, sound effects and/or music and crowd background. The rough draft may be further edited. The scene script may be monitored to ensure that various timing requirements are met.

In an embodiment, multiple layers from the scene of the action footage may be compressed into a single layer to create a single video scene with one or more elements removed. A video may include multiple layers where each layer may include, but is not limited to, a foreground image, a background image, background music and/or foreground music. The single video scene still may be added back to the moving footage. A generic slate and motion tracking may be used to combine the moving and still footage. Two non-moving points from the action footage may be used to create key frames of the movements in the footage. The edited action footage may be added to the footage of the reenacted scene.

In order to increase the realism of the media product, the image on the recording may be resized to conform to a size chart. The size chart is a chart that may be used to correctly size the actor from the reenacted scene into the scene from the action footage. This may enable the media product to look more realistic. The chart may be based on the originally shot angles and the size of the player in the scene from the action footage. For example, if the player was six feet tall and the participant is only four feet tall, the participant may be resized by two feet.

In various embodiments, a repositioning effect may be applied for vertical and horizontal proportioning. Color corrections, blur effects and shadow effects may be used to match the action footage with footage from the reenacted scene. After the action footage is merged with the footage from the reenacted scene, the motion tracked key frames may be linked from the action footage to the footage from the reenacted scene to make both scenes look and move as a single scene.

For example, the scene may be a pitching scene, and the participant may look as if he is throwing the ball. A digital still of the ball from the action footage may be taken. One or more layers in the action footage may be removed until only a single layer containing the ball remains. The prop ball may be thrown by the participant at the same time as the ball in the action footage is released. However, the media product will not display the prop ball that the participant throws. Instead, the real ball thrown by the player may be shown on the media product. The real ball may then be caught in a catcher's glove. In an embodiment, a perspective and resize effect may make the true ball smaller and may arc the path of the true ball to create realism. In an embodiment, compositing software may be used for purposes such as, but not limited to, correcting errors made while recording the participant and/or creating greater after effects. For different sized people, a null object may be added to the effect. Each scene may be inserted into the edited sequence.

For car racing scenes, one scene may have the participant pulling ahead of another car. The next scene may switch from a picture of the participant behind the steering wheel to real footage of one car pulling ahead of another car on the racetrack. The compositing programs may be used to make such scenes look realistic.

In an embodiment, various insignia or logos may be added to the video. The form of insignia or logos may be depicted, for example, on a billboard in a ballpark, on a vertical surface of a seating section of a ballpark, on a sideboard on a race track, on a backdrop and/or on a microphone used for an interview scene. Other effects may be added such as, but not limited to, a quote for the video introduction, a scoreboard to show the statistics of the participant and/or the score of the game, a recap of the participant's highlights and/or an interview with participant during and/or at the conclusion of a sporting event.

Once the processing of the recording is complete, the media product may be converted 250 to a predetermined video file format. The video file may be made available via the Internet and/or on a DVD.

It will be appreciated that various of the above-disclosed and other features and functions, or alternatives thereof may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A system for creating a customized video, the system comprising:
a memory configured to store a digital representation of a scene from action footage of a sporting event;
a portable structure configured to provide a location to reenact the scene, wherein the structure comprises a surface of the structure comprising a monochromatic material;
one or more props related to the scene;
a camera configured to record a reenacted scene inside the structure; and
a computing device configured to merge the reenacted scene with the scene from the action footage to create a customized video in which the monochromatic material is replaced by the action footage.

2. The system of claim 1 wherein the scene from the action footage comprises one or more of the following:
an award ceremony, an interview and a sporting event.

3. The system of claim 1, further comprising:
one or more back lighting structures.

4. The system of claim 1, further comprising:
one or more markers for positioning a participant.

5. The system of claim 1 wherein the one or more props comprise one or more of the following:
a baseball glove,
a baseball uniform,
a baseball hat, and
a baseball.

6. The system of claim 1 wherein the portable structure comprises a tent.

7. The system of claim 1 wherein the portable structure comprises a truss.

8. The system of claim 1 wherein the monochromatic material is further configured to cover a floor, wherein the floor comprises an elevated area representing a pitcher's mound.

9. A method of creating a customized video, the method comprising:
preparing a portable structure, wherein a surface of the structure comprises a monochromatic material, and wherein one or more props are positioned inside the structure;
receiving a scene from action footage of a sporting event;
recording a reenacted sports scene inside the portable structure; and
merging the recording of the reenacted sports scene with at least a portion of the scene from the action footage to create the customized video in which the monochromatic material is replaced by the action footage.

10. The method of claim 9 wherein the recording the reenacted scene comprises one or more of the following:
recording an interview;
recording a fly ball being caught; and
recording a player hitting a homerun.

11. The method of claim 9 wherein the recording the reenacted scene comprises playing sound effects to assist a participant.

12. The method of claim 9 wherein the preparing the portable system further comprises one or more of:
setting up one or more props;
setting up one or more markers; and
setting up the lighting.

13. The method of claim 9, further comprising:
providing props associated with the action footage.

14. The method of claim 9, further comprising:
adjusting one or more markers based on a height of a participant.

15. The method of claim 9, further comprising:
adjusting the monochromatic material based on a height of a participant.

16. A method of creating a customized sports video, the method comprising:
preparing a portable structure, comprising:
setting up monochromatic material on two sides and a portion of a floor of the structure,
setting up one or more props inside the portable structure, and
setting up one or more markers inside the portable structure;
receiving a scene from action footage of a sporting event;
recording a reenacted sports scene inside the portable structure; and
merging the recording of the reenacted sports scene with at least a portion of the scene from the action footage to create a customized video in which the monochromatic material is replaced by the action footage.

17. The method of claim 15, further comprising:
editing the action footage and the reenacted sports scene.

18. The method of claim 15, further comprising:
adjusting the one or more markers based on a height of a participant.

19. The method of claim 15 wherein the setting up monochromatic material comprises setting up monochromatic material to cover an elevated area on the floor representing a pitcher's mound.

20. The method of claim 15 wherein the recording the reenacted scene comprises playing sound effects to assist a participant.

21. The method of claim 15 wherein the recording the reenacted scene comprises one or more of the following:
recording an interview;
recording a touchdown; and
recording an awards ceremony.
